(19) United States
(12) Patent Application Publication
(10) Pub. No.: US 2011/0144901 A1
(43) Pub. Date: Jun. 16, 2011

(54) Method for Playing Voice Guidance and Navigation Device Using the Same

(76) Inventor: Zhanyong Wang, Anhui Province (CN)

(21) Appl. No.: 12/373,794

(22) PCT Filed: Aug. 29, 2008
(86) PCT No.: PCT/CN2008/072202

§ 371 Date: Jan. 14, 2009

(51) Int. Cl. G01C 21/00

(52) U.S. Cl. 701/201

(57) ABSTRACT

The invention provides a navigation device capable of playing voice guidance. In one embodiment, the navigation device comprises a GNSS receiver, a Geographic Information System (GIS), a control module, an audio processing module, and a speaker. The GNSS receiver provides a position, a velocity, and an acceleration of the navigation device. The GIS determines a route according to a map data and determines a decision point in the route. The control module dynamically determines a playing policy corresponding to the decision point according to the position, velocity, and acceleration, and generates a guiding sentence corresponding to the decision point according to the playing policy, wherein the playing policy determines a number of words in the guiding sentence. The audio processing module then generates a guiding voice signal corresponding to the guiding sentence. The speaker then plays the guiding voice signal.

### BACKGROUND OF THE INVENTION

1. Field of the Invention

The invention relates to navigation devices, and more particularly to playing voice guidance for navigation devices.

2. Description of the Related Art

A navigation device is a device guiding a user to reach a target position designated by the user. An ordinary navigation device comprises a Global Navigation Satellite System (GNSS) receiver and a Geographic Information System (GIS). The GNSS receiver provides a current location of the navigation device. The GIS provides a road map of the area where the navigation device is located. The navigation device then determines the shortest route leading the user from the current location to the target position according to the road map. The user therefore can then proceed along the route according to instructions of the navigation device to reach the target position.

An ordinary navigation device issues voice guidance corresponding to decision points in the route to instruct a user for navigation. Examples of decision points are corners, crossroads, bridges, tunnels, and circular paths. A navigation device therefore comprises an audio processing module to play the voice guidance. In one embodiment, the audio processing module plays sound signals recorded in advance as the voice guidance. In another embodiment, the audio processing module is a text-to-speech (TTS) module which converts a guiding sentence from text to speech to obtain the voice guidance.

Both of the aforementioned embodiments play the voice guidance at a constant length. Namely, changes in speed of a moving navigation device, does not alter changes in length of the voice guidance. For example, with users often using the navigation device when driving a car, when the speed of the car exceeds 90 kilometers per hour, due to a constant length of the voice guidance, the car often passes a decision point corresponding to the voice guidance.

Because late voice guidance is useless to the user, a conventional navigation device often disables the audio processing module when the speed of the navigation device exceeds a threshold level. However, when the audio processing module is disabled, the user is unable to receive instructions from the navigation device. Thus in this case, the user must solely rely upon the provided road map shown on a screen of the navigation device for navigation, which is very inconvenient for the user. Thus, a navigation device capable of dynamically adjusting length of the voice guidance according to the speed of the navigation device is provided.

### BRIEF SUMMARY OF THE INVENTION

The invention provides a navigation device capable of playing voice guidance. In one embodiment, the navigation device comprises a GNSS receiver, a Geographic Information System (GIS), a control module, an audio processing module, and a speaker. The GNSS receiver provides a position, a velocity, and an acceleration of the navigation device. The GIS determines a route according to a map data and determines a decision point in the route. The control module dynamically determines a playing policy corresponding to the decision point according to the position, velocity, and acceleration, and generates a guiding sentence corresponding to the decision point according to the playing policy, wherein the playing policy determines a number of words in the guiding sentence. The audio processing module then generates a guiding voice signal corresponding to the guiding sentence. The speaker then plays the guiding voice signal.

The invention further provides a method for playing voice guidance for a navigation device. First, a position, a velocity, and an acceleration of the navigation device is obtained from a GNSS receiver. A route and a decision point in the route is then obtained from a Geographic Information System (GIS). A playing policy corresponding to the decision point is then dynamically determined according to the position, the velocity, and the acceleration with a control module. A guiding sentence corresponding to the decision point is then generated according to the playing policy, wherein the playing policy determines a number of words in the guiding sentence. A guiding voice signal is then generated according to the guiding sentence. Finally, the guiding voice signal is played with a speaker.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a navigation device according to the invention;

FIG. 2A is a block diagram of an embodiment of a control module according to the invention;

FIG. 2B is a block diagram of another embodiment of a control module according to the invention;

FIG. 3 shows a relationship between a remaining distance, an alert distance, and a guard distance corresponding to a decision point;

FIG. 4 is a flowchart of a method for dynamically adjusting lengths of guidance sentences according to a velocity of a navigation device according to the invention;

FIG. 5A shows an example of guiding sentences corresponding to different single-sentence playing policies according to the invention;

FIG. 5B shows an example of guiding sentences corresponding to different combined-sentence playing policies according to the invention;

FIG. 6A is a schematic diagram of a road map;

FIG. 6B is a schematic diagram showing two kinds of relationships between the alert distances of two decision points of FIG. 6A;

FIG. 7 is a flowchart of a method for determining a playing policy of a guiding sentence according to the invention; and

FIG. 8 is a flowchart of a method for playing voice guidance for a navigation device according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

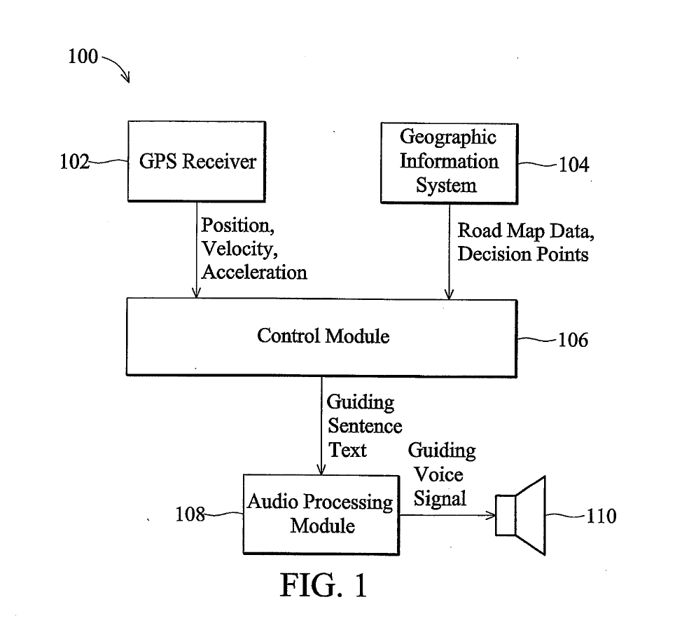

Referring to FIG. 1, a block diagram of a navigation device 100 according to the invention is shown. The navigation device 100 comprises a GNSS receiver 102, a Geographic Information System (GIS) 104, a control module 106, an audio processing module 108, and a speaker 110. The GNSS receiver 102 provides position information, such as a current position, a velocity, and an acceleration of the navigation device. In some embodiment, according to the position on time from the GNSS receiver the velocity and the acceleration of the navigation device can be determined by the navigation device. The GIS 104 stores a road map data. When a user of the navigation device 100 selects a target place from the road map, the GIS 104 determines a route from the current position to the target place according to the road map data. The user can therefore proceed along the route to reach the target place according to instructions of the navigation device 100.

To instruct the user for navigation, the GIS 104 determines a plurality of decision points worth special reminders along the route. Examples of decision points are corners, intersections, bridges, tunnels, and circulating paths along the route, and the navigation device 100 must inform the user of the right direction leading to the target place before the user proceeds to the decision points. For example, when the user proceeds to a decision point of an intersection, the navigation device must instruct the user to “go straight”, “turn right”, or “turn left”, so as to instruct the user on how to reach the targeted place.

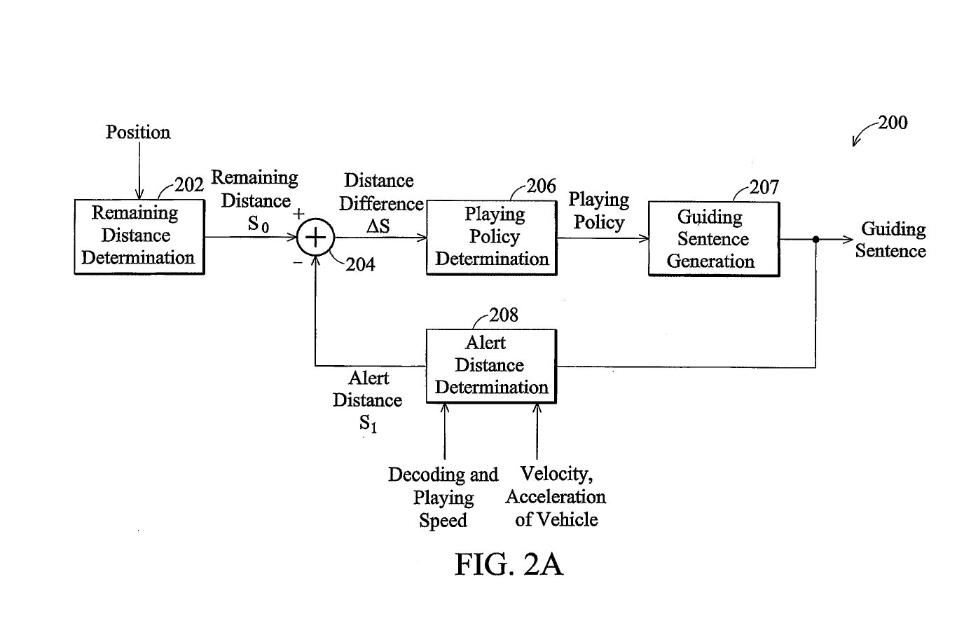

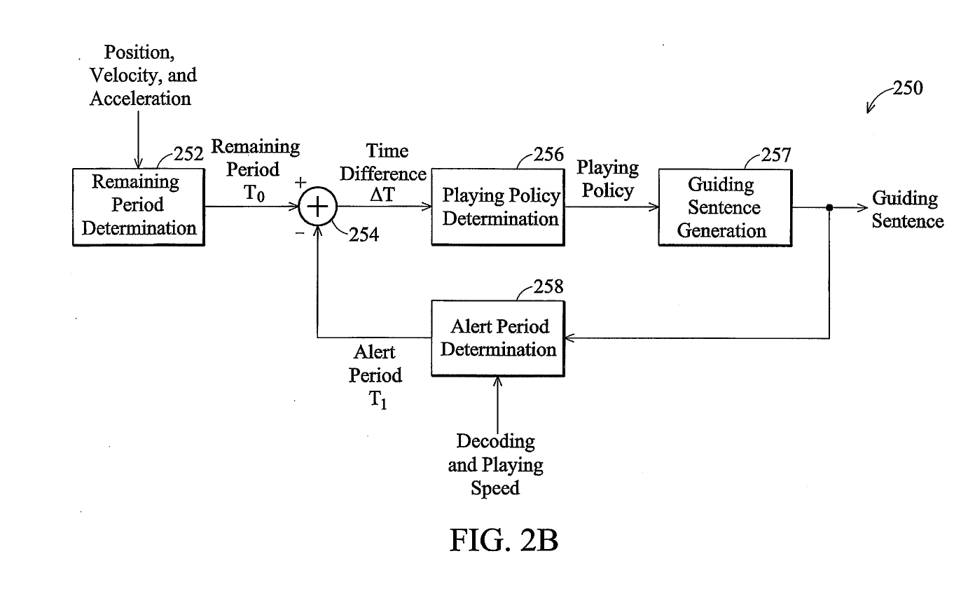

The control module 106 then determines playing policies of guiding sentences corresponding to the decision points according to the position, the velocity, and the acceleration, wherein the playing policies respectively determine numbers of words in the guiding sentences corresponding to the decision points. A guiding sentence corresponding to a decision point comprises instructions for the decision point. For example, a decision point of an intersection has a corresponding guiding sentence of “Please turn left at the intersection to enter Queen's Avenue”. The control module 106 then generates guiding sentences corresponding to the decision points according to the playing policies thereof. Thus, the lengths of the guiding sentences are dynamically adjusted according to the position, the velocity, and the acceleration of the navigation device 100. The control module 106 is further described in detail with FIGS. 2A and 2B.

The audio processing module 108 then generates guiding voice signals corresponding to the guiding sentences. In one embodiment, the audio processing module is a text-to-speech (TTS) module which converts the guiding sentences from text to speech to obtain the guiding voice signals. The speaker then plays the guiding voice signals before the navigation device 100 moves along the route to the decision points. Thus, the user can take actions according to instructions of the guiding voice signals to drive a car towards the most efficient directions at the decision points along the route, to finally reach the targeted place.

Referring to FIG. 2A, a block diagram of an embodiment of a control module 200 according to the invention is shown. The control module 200 comprises a remaining distance determination module 202, a comparator 204, a playing policy determination module 206, guiding sentence generation module 207, and an alert distance determination module 208. The playing policy determination module 206 first determines a playing policy corresponding to a decision point according to a distance difference ΔS. A guiding sentence generation module 207 then generates a guiding sentence corresponding to the decision point according to the playing policy.

The alert distance determination module 208 first calculates a playing period T₁ for playing the guiding sentence according to a decoding and playing speed for the guiding sentence. The playing period T₁ is the time required by the audio processing module 108 to completely play the guiding voice signal corresponding to the guiding sentenced with the decoding and playing speed. The alert distance determination module 208 then determines an alert distance S₁ of the guiding sentence according to the playing period T₁, the velocity, and the acceleration. The alert distance S₁ is a distance traversed by the navigation device 100 with the velocity and the acceleration provided by the GNSS receiver 102 during the playing period T₁.

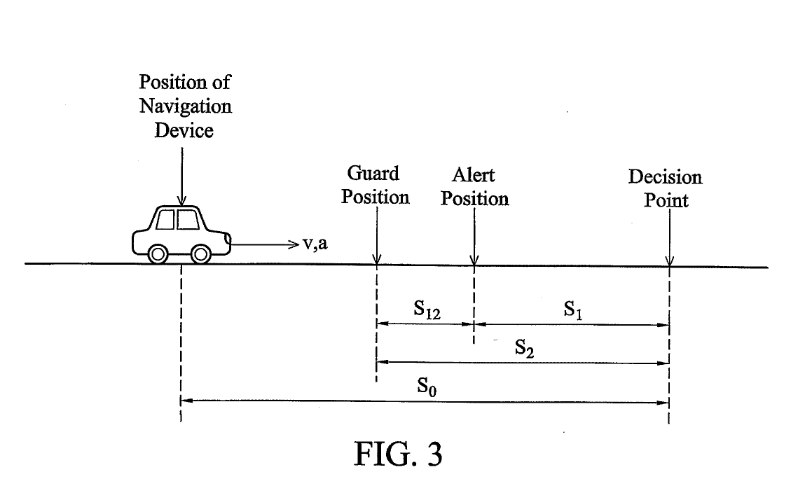

The remaining distance determination module 202 calculates a remaining distance S₀ between locations of the navigation device 100 and the decision point. Referring to FIG. 3, a relationship between a remaining distance S₀ and an alert distance S₁ corresponding to a decision point is shown. The comparator 204 then compares the alert distance S₁ with the remaining distance S₀ to obtain the distance difference ΔS. If the distance difference ΔS indicate that the alert distance S₁ is greater than the remaining distance S₀, the navigation device 100 will have passed the decision point when the guiding sentence is completely played, and the playing policy determination module 206 determines a playing policy to reduce a number of words in the guiding sentence. Otherwise, if the distance difference ΔS indicates that the alert distance S₁ is less than the remaining distance S₀, the audio processing module 108 will complete playing of the guiding sentence before the navigation device 100 passes the decision point, and the playing policy determination module 206 determines a playing policy allowing the guiding sentence to use a greater number of words.

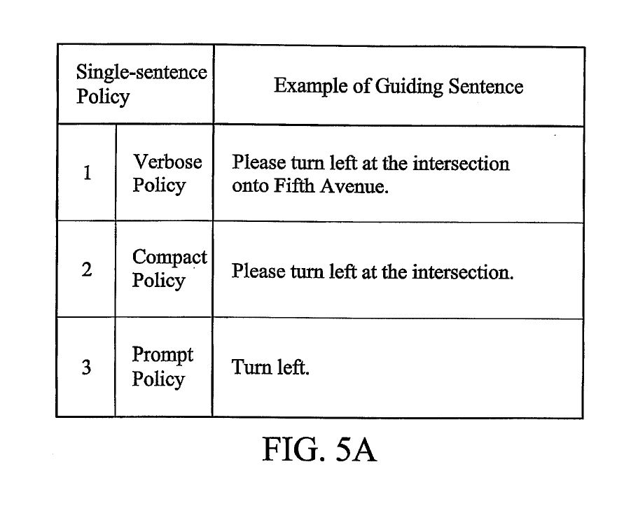

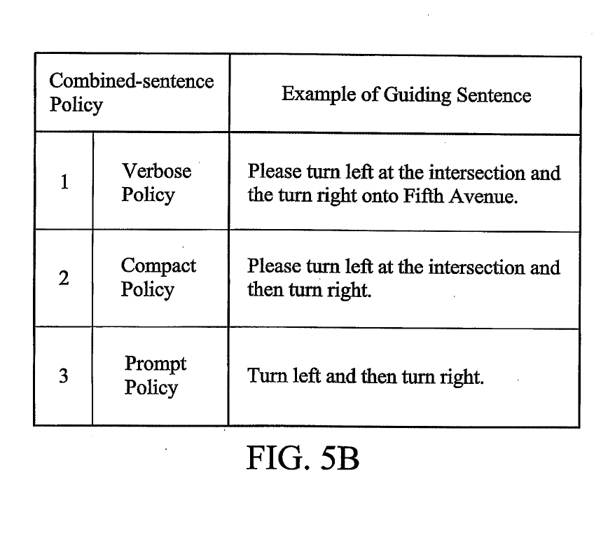

Referring to FIG. 5A, an example of guiding sentences corresponding to different single-sentence playing policies is shown. In one embodiment, the playing policy are selected from a verbose policy, a compact policy, and a prompt policy. The verbose policy allows the guiding sentence to use a greater number of words. For example, a guiding sentence for a decision point of an intersection may be “Please turn left at the intersection onto Fifth Avenue”. The compact policy allowing the guiding sentence to use a moderate number of words, and a guiding sentence for the decision point of the intersection may be “Please turn left at the intersection”. The prompt allowing the guiding sentence to use a lesser number of words, and a guiding sentence for the decision point of the intersection may be only “Turn left”.

Referring to FIG. 2B, a block diagram of an embodiment of a control module 250 according to the invention is shown. The control module 250 comprises a remaining period determination module 252, a comparator 254, a playing policy determination module 256, a guiding sentence generation module 257, and an alert period determination module 258. The playing policy determination module 256 first determines a playing policy corresponding to a decision point according to a time difference ΔT. The guiding sentence generation module 257 then generates a guiding sentence corresponding to the decision point according to the playing policy.

The alert period determination module 258 calculates an alert period T₁ for playing the guiding sentence according to the decoding and playing speed for the guiding sentence. The alert period T₁ is the time required by the audio processing module 108 to completely play the guiding voiced signal corresponding to the guiding sentence with the decoding and playing speed. The remaining period determination module 252 then calculates a remaining period T₀ according to the position, the velocity, and the acceleration of the navigation device 100. The remaining period T₀ is a time required by the navigation device 100 to proceed from the position to the decision point with the velocity and the acceleration provided by the GNSS receiver 102.

The comparator 254 then compares the alert period T₁ with the remaining period T₀ to obtain the time difference ΔT. If the time difference ΔT indicates that the alert period T₁ is greater than the remaining period T₀, the navigation device 100 will have passed the decision point when the guiding sentence is completely played, and the playing policy determination module 256 determines a playing policy to reduce a number of words in the guiding sentence. Otherwise, if the time difference ΔT indicates that the alert period T₁ is less than the remaining period T₀, the audio processing module 108 will complete playing of the guiding sentence before the navigation device 100 passes the decision point, and the playing policy determination module 256 will determine a playing policy allowing the guiding sentence to use a greater number of words.

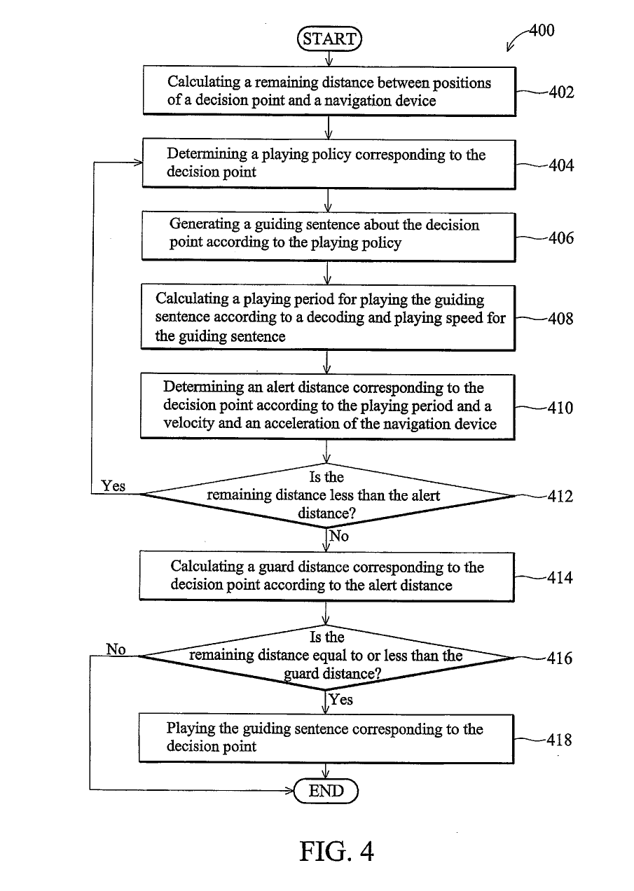

Referring to FIG. 4, a flowchart of a method 400 for dynamically adjusting lengths of guidance sentences according to a velocity of a navigation device 100 according to the invention is shown. First, the control module 106 calculates a remaining distance S₀ between positions of a decision point and the navigation device 100 (step 402). The control module 106 then determines a playing policy of a guiding sentence corresponding to a decision point (step 404). The control module 106 then generates the guiding sentence according to the playing policy (step 406). The control module 106 then calculates a playing period T₁ for playing the guiding sentence according to a decoding and playing speed for the guiding sentence (step 408).

The control module 106 then determines an alert distance S₁ corresponding to the decision point according to the playing period T₁ and a velocity and an acceleration of the navigation device 100 (step 410). The control module 106 then compares a remaining distance S₀ with the alerting distance S₁ (step 412). If the remaining distance S₀ is less than the alert distance S₁, the control module 106 changes the playing policy for playing the guiding sentence to reduce the number of words in the guiding sentence (step 404). Otherwise, the control module 106 calculates a guard distance S₂ corresponding to the decision point according to the alert distance S₁ (step 414).

Referring to FIG. 3, a guard distance S₂ corresponding to a decision point is shown. The guard distance S₂ is a distance between a guard position and the position of the decision point and is greater than the alert distance S₁. The guard distance S₂ is obtained by adding a distance S₁₂ to the alert distance S₁. In one embodiment, the distance S₁₂ is a fixed distance. In another embodiment, the distance S₁₂ is a distance traversed by the navigation device 100 with the velocity and the acceleration during 1 second. In another embodiment, the distance S₁₂ should comprise one sample point from the GPS receiver. The control module 106 then checks whether the remaining distance S₀, the distance between the navigation device 100 and the decision point, is equal to or less than the guard distance S₂ (step 416). If the remaining distance S₀ is equal to or less than the guard distance S₂, the control module 106 directs the audio processing module 108 to start to play the guiding sentence corresponding to the decision point (step 418). Because the guard distance S₂ is greater than the alert distance S₁, the guiding sentence is assured of completely playing before the navigation device 100 passes the decision point.

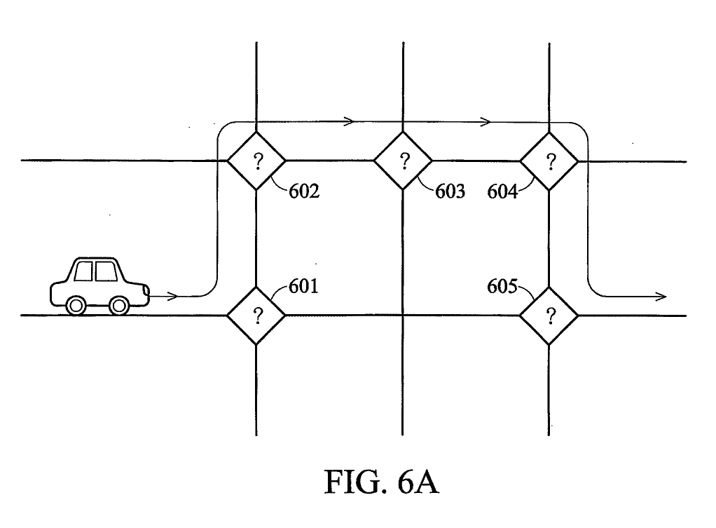

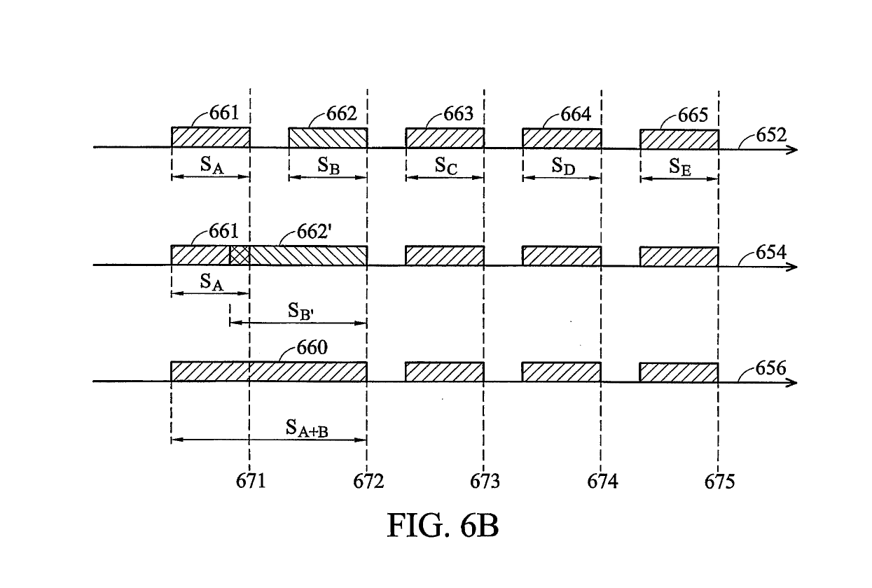

Referring to FIG. 6A, a schematic diagram of a road map is shown. A navigation device is located at the position 620. A route 610 leads the navigation device from the location 620 to a target place, and five decision points 601˜605 are inserted in the route 610. The navigation device then respectively calculates alert distances corresponding to the decision points 601˜605 according to the method 400 of FIG. 4. Referring to FIG. 6B, a schematic diagram showing two kinds of relationships between the alert distances of the two decision points 601 and 602 of FIG. 6A is shown. Three routes 652, 654, and 656 corresponding to the route 610 is shown, and the locations 671, 672, 673, 674, and 675 respectively corresponds to the locations of decision points 601, 602, 603, 604, and 605 in route 610.

After the navigation device performs the method 400, five alerting distances S_{A}, S_{B} (or S_{B}′ in the case of route 654), S_{C}, S_{D}, and S_{E} respective corresponding to the decision points 601, 602, 603, 604, and 605 are obtained. In the case of route 652, the alerting distance corresponds to the decision point 602 is S_{B}, and the distance between the location 671 of the decision point 601 and the location 672 of the decision point 602 is greater than the alerting distance S_{B}. Thus, the navigation device can complete playing of the guiding sentence corresponding to the decision point 602 before the navigation device passes the decision point 602. In the case of route 654, the alerting distance corresponds to the decision point 602 is S_{B}′, and the distance between the location 671 of the decision point 601 and the location 672 of the decision point 602 is less than the alerting distance S_{B}′.

In the case of route 654, the navigation device therefore can not complete playing of the guiding sentence corresponding to the decision point 602 before the navigation device passes the decision point 602. Thus, a control module of the navigation device combines the guiding sentence corresponding to the decision point 601 with the guiding sentence corresponding to the decision point 602 to obtain a combined guiding sentence. The control module of the navigation device then determines an alert distance S_{A+B} according to the combined guiding sentence, and directs an audio processing module to play the combined guiding sentence rather than respectively playing the single guiding sentences. Route 656 shows the case in which the combined guiding sentence corresponding to both the decision points 601 and 602 are played, and the problem of the case of route 564 is solved.

For example, a guiding sentence corresponding to the decision point 601 is “Please turn left at the intersection onto Fifth Avenue” with 9 words, and a guiding sentence corresponding to the decision point 602 is “Please turn right at the intersection onto Queen's Avenue” with 9 words. A combined sentence of the guiding sentences corresponding to the decision points 601 and 602 then may be “Please turn left at the intersection and then turn right onto Queen's Avenue” with 13 words. The length of the combined guiding sentence is less than a sum of the lengths of the two single guiding sentences, and the time required for playing the combined guiding sentence is less than the time required for playing two guiding sentences.

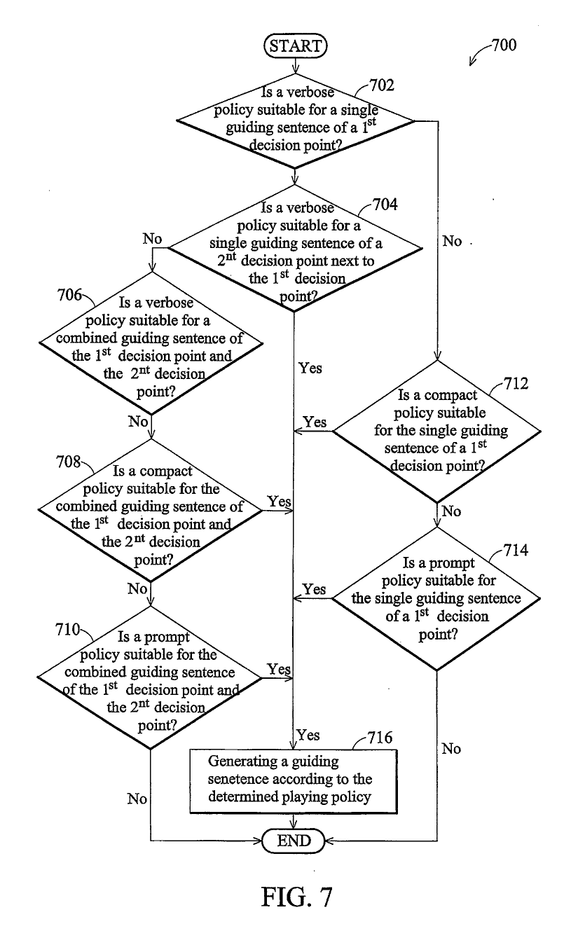

Referring to FIG. 7, a flowchart of a method 700 for determining a playing policy of a guiding sentence according to the invention is shown. A playing policy determination module of a control module first selects a verbose policy corresponding to a first decision point (step 702), and a guiding sentence is then generated according to the verbose policy. If a comparison module finds that an alert distance of the guiding sentence is greater than a remaining sentence or an alert period of the guiding sentence is greater than a remaining period, the verbose policy is not suitable for the first decision point, and the playing policy determination module selects a compact policy for the decision point (step 712). If the compact policy is not suitable for the first decision point, a prompt policy is selected to generate a guiding sentence for the first decision point (step 714).

If the verbose policy is suitable for the first decision point (step 702), the playing policy determination module selects a verbose policy for a second decision point next to the first decision point (step 704). If the verbose policy is not suitable for the second decision point, such as the case of route 654 in FIG. 6B, the playing policy determination module combines the guiding sentences of the first decision point and the second decision point to obtain a combined guiding sentence and selects a verbose policy for the combined guiding sentence (step 706). Referring to FIG. 5B, an example of guiding sentences corresponding to different combined-sentence playing policies is shown. If the verbose policy is not suitable for the combined guiding sentence, a compact policy is selected (step 708). If the compact policy is still not suitable for the combined guiding sentence, a prompt policy is selected (step 710). After a playing policy is determined, the guiding sentence is generated according to the playing policy (step 716).

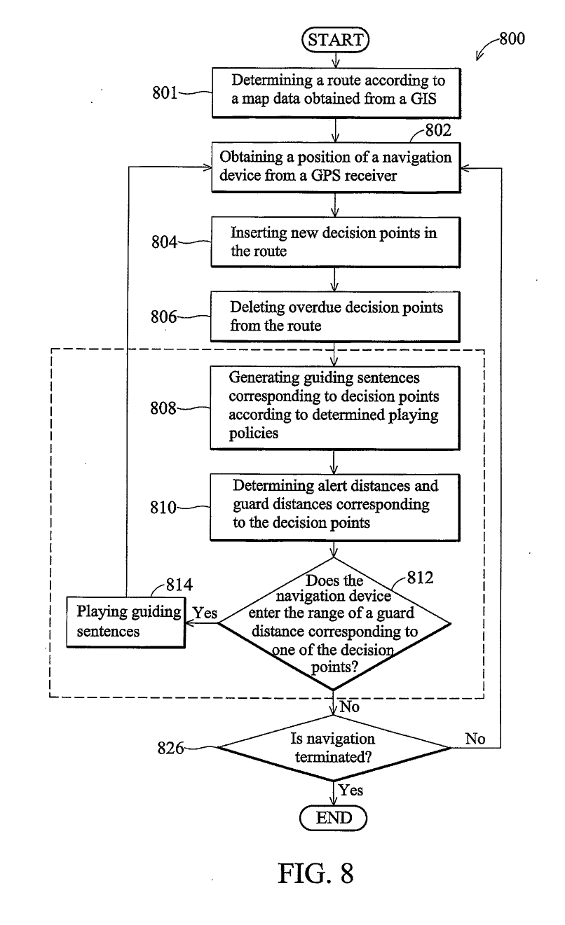

Referring to FIG. 8, a flowchart of a method 800 for playing voice guidance for a navigation device 100 according to the invention is shown. A route is first determined according to a road map data obtained from a GIS 104 (step 801). A position, a velocity, and an acceleration of the navigation device 100 is then obtained from a GNSS receiver 102 (step 802). The navigation device 100 then inserts new decision points in the route (step 804). After the navigation device 100 passes some overdue decision points, the overdue decision points are then deleted from the route (step 806).

A control module 106 then respectively determines playing policies corresponding to decision points according to the position, the velocity, the acceleration of the navigation device 100 according to the method 700, and then generates guiding sentences corresponding to the decision points according to the determined playing policies (step 808). The control module 106 then determines alert distances and guard distances corresponding to the decision points (step 810). If the navigation device 100 enters the range of a guard distance corresponding to one of the decision points (step 812), an audio processing module 108 then plays a guiding sentence (step 814). Otherwise, the playing policies, the guiding sentences, the alert distances, and the guard distances are repeatedly calculated according to new velocity of the navigation device 100 until a navigation function of the navigation device 100 is terminated (step 816). The steps 808, 810, 812, and 814 encircled by a dotted line 820 are the process disclosed by the method 400 of FIG. 4.

The invention provides a navigation device. The navigation device dynamically adjusts lengths of guiding sentences corresponding to decision points according to position, velocity, and acceleration with a control module. Thus, the guiding sentences are sounded with a length suitable for the speed of the navigation device even if the speed is high.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A navigation device capable of playing voice guidance, comprising:
a Global Navigation Satellite System (GNSS) receiver, providing a position information of the navigation device;
a Geographic Information System (GIS), determining a route according to a map data, and determining a decision point in the route;
a control module, coupled to the GNSS receiver and the GIS, dynamically determining a playing policy corresponding to the decision point according to the position information, and generating a guiding sentence corresponding to the decision point according to the playing policy;
an audio processing module, coupled to the control module, generating a guiding voice signal corresponding to the guiding sentence; and
a speaker, coupled to the audio processing module, playing the guiding voice signal.

2. The navigation device as claimed in claim 1, wherein the audio processing module is a text-to-speech (TTS) module, converting the guiding sentence from text to speech to obtain the guiding voice signal.

3. The navigation device as claimed in claim 1, wherein the playing policy are selected from a verbose policy, a compact policy, and a prompt policy, and the verbose policy allows the guiding sentence to use a greater number of words, the compact policy allows the guiding sentence to use a moderate number of words, and the prompt allows the guiding sentence to use a less number of words.

4. The navigation device as claimed in claim 1, wherein the control module further determines an alert distance of the guiding sentence according to a velocity of the navigation device, an acceleration of the navigation device, and a decoding and playing speed for the guiding sentence, determines a guard distance greater than the alert distance, and directs the audio processing module to play the guiding sentence when a distance between the navigation device and the decision point is less than the guard distance, wherein the navigation device will completely traverse the alert distance with the velocity and the acceleration during a period in which the audio processing module completely plays the guiding sentence with the decoding and playing speed.

5. The navigation device as claimed in claim 4, wherein the GIS further determines a second decision point subsequent to the decision point in the route, and the control module further dynamically determines a second playing policy corresponding to the second decision point according to the position, the velocity, and the acceleration, and generates a second guiding sentence corresponding to the second decision point according to the second playing policy.

6. The navigation device as claimed in claim 1, wherein the control module comprises:
a playing policy determination module, determining the playing policy corresponding to the decision point according to a distance difference;
a guiding sentence generation module, generating the guiding sentence corresponding to the decision point according to the playing policy;
an alert distance determination module, calculating a playing period for playing the guiding sentence according to the guiding sentence and a decoding and playing speed for the guiding sentence, determining an alert distance of the guiding sentence according to the playing period, a velocity, and an acceleration of the navigation device, wherein the navigation device will completely traverse the alert distance with the velocity and the acceleration during the playing period;
a remaining distance determination module, calculating a remaining distance between the navigation device and the decision point; and
a comparison module, comparing the alert distance with the remaining distance to obtain the distance difference.

7. The navigation device as claimed in claim 6, wherein the playing policy determination module determines the playing policy to allow the guiding sentence to use a greater number of words when the distance difference indicates that the alert distance is shorter than the remaining distance, and the playing policy determination module determines the playing policy to reduce the number of words in the guiding sentence when the distance difference indicates that the alert distance is greater than the remaining distance.

8. The navigation device as claimed in claim 1, wherein the control module comprises:
a playing policy determination module, determining the playing policy corresponding to the decision point according to a time difference;
a guiding sentence generation module, generating the guiding sentence corresponding to the decision point according to the playing policy;
an alert period determination module, calculating an alert period for playing the guiding sentence according to the guiding sentence and a decoding and playing speed for the guiding sentence;
a remaining period determination module, calculating a remaining period during which the navigation device proceeds from the position to the decision point according to the position, a velocity, and an acceleration of the navigation device; and
a comparison module, comparing the alert period with the remaining period to obtain the time difference.

9. The navigation device as claimed in claim 8, wherein the playing policy determination module determines the playing policy to allow the guiding sentence to use a greater number of words when the time difference indicates that the alert period is shorter than the remaining period, and the playing policy determination module determines the playing policy to reduce the number of words in the guiding sentence when the time difference indicates that the alert period is greater than the remaining period.

10. The navigation device as claimed in claim 5, wherein the control module determines a second alert distance of the second guiding sentence according to the velocity, the acceleration, and the decoding and playing speed, combines the guiding sentence with the second guiding sentence to obtain a combined guiding sentence when the distance between the decision point and the second decision point is greater then the second alerting distance, and directs the audio processing module to play the combined guiding sentence rather than respectively playing the guiding sentence and the second guiding sentence, wherein the combined guiding sentence has a word number less than sum of the word numbers of the guiding sentence and the second guiding sentence, and the navigation device will completely traverse the second alert distance with the velocity and the acceleration during a period in which the audio processing module completely plays the second guiding sentence with the decoding and playing speed.

11. A method for playing voice guidance for a navigation device, comprising:
obtaining a position information of the navigation device;
obtaining a route and a decision point in the route from a Geographic Information System (GIS);
dynamically determining a playing policy corresponding to the decision point according to the position information; and
generating a guiding sentence corresponding to the decision point according to the playing policy;
wherein the playing policy determines a number of words in the guiding sentence.

12. The method as claimed in claim 11, wherein generation of the guiding voice signal comprises converting the guiding sentence from text to speech to obtain the guiding voice signal, and the audio processing module is a text-to-speech (TTS) module.

13. The method as claimed in claim 11, wherein the playing policy are selected from a verbose policy, a compact policy, and a prompt policy, the verbose policy allows the guiding sentence to use a greater number of words, a compact policy allows the guiding sentence to use a moderate number of words, a prompt allows the guiding sentence for a less to use a lesser number of words.

14. The method as claimed in claim 11, wherein the method further comprises:
determining an alert distance of the guiding sentence according to a velocity and an acceleration of the navigation device, and a decoding and playing speed for the guiding sentence;
determining a guard distance greater than the alert distance; and
playing the guiding voice signal when a distance between the navigation device and the decision point is less than the guard distance;
wherein the navigation device will completely traverse the alert distance with the velocity and the acceleration during a period in which the guiding sentence have being played.

15. The method as claimed in claim 14, wherein the method further comprises:
obtaining a second decision point subsequent to the decision point in the route;
dynamically determining a second playing policy corresponding to the second decision point according to the position, the velocity, and the acceleration; and
generating a second guiding sentence corresponding to the second decision point according to the second playing policy.

16. The method as claimed in claim 15, wherein the method further comprises:
determining a second alert distance of the second guiding sentence according to the velocity, the acceleration, and the decoding and playing speed;
combining the guiding sentence with the second guiding sentence to obtain a combined guiding sentence when the distance between the decision point and the second decision point is greater then the second alerting distance; and
playing the combined guiding sentence instead of respectively playing the guiding sentence and the second guiding sentence;
wherein the combined guiding sentence has a word number less than the sum of the word numbers of the guiding sentence and the second guiding sentence, and the navigation device will completely traverse the second alert distance with the velocity and the acceleration during a period in which the audio processing module completely plays the second guiding sentence with the decoding and playing speed.

17. The method as claimed in claim 11, wherein the determination of the playing policy comprises:
determining the playing policy corresponding to the decision point according to a distance difference;
generating the guiding sentence corresponding to the decision point according to the playing policy;
calculating a playing period for playing the guiding sentence according to a decoding and playing speed for the guiding sentence;
determining an alert distance of the guiding sentence according to the playing period, the velocity, and the acceleration, wherein the navigation device will completely traverse the alert distance with the velocity and the acceleration during the playing period;
calculating a remaining distance between the navigation device and the decision point; and
comparing the alert distance with the remaining distance to obtain the distance difference.

18. The method as claimed in claim 17, wherein the playing policy is determined to allow the guiding sentence to use a greater number of words when the distance difference indicates that the alert distance is shorter than the remaining distance, and the playing policy is determined to allow the guiding sentence to use a lesser number of words when the distance difference indicates that the alert distance is greater than the remaining distance.

19. The method as claimed in claim 11, wherein the determination of the playing policy comprises:
determining the playing policy corresponding to the decision point according to a time difference;
generating the guiding sentence corresponding to the decision point according to the playing policy;
calculating an alert period for playing the guiding sentence according to a decoding and playing speed;
calculating a remaining period during which the navigation device proceeds from the position to the decision point according to the position, the velocity, and the acceleration; and
comparing the alert period with the remaining period to obtain the time difference.

20. The method as claimed in claim 19, wherein the playing policy is determined to allow the guiding sentence to use a greater number of words when the time difference indicates that the alert period is shorter than the remaining period, and the playing policy is determined to allow the guiding sentence to use a lesser number of words when the time difference indicates that the alert period is greater than the remaining period.
